(19) United States
(12) Patent Application Publication
(10) Pub. No.: US 2025/0226582 A1
(43) Pub. Date: Jul. 10, 2025

(54) ANTENNA MODULE

(71) Applicant: Murata Manufacturing Co., Ltd., Nagaokakyo-shi (JP)

(72) Inventors: Keiichi ICHIKAWA, Nagaokakyo-shi (JP); Kosuke NISHIO, Nagaokakyo-shi (JP)

(73) Assignee: Murata Manufacturing Co., Ltd., Nagaokakyo-shi (JP)

(21) Appl. No.: 19/091,840

(22) Filed: Mar. 27, 2025

Related U.S. Application Data
(63) Continuation of application No. PCT/JP2023/032710, filed on Sep. 7, 2023.

(30) Foreign Application Priority Data
Oct. 11, 2022 (JP) 2022-163056

(51) Int. Cl. H01Q 9/04; H01Q 1/38

(52) U.S. Cl. CPC H01Q 9/0407; H01Q 1/38

(57) ABSTRACT

An antenna structure has a second positive main surface that is in contact with a first negative main surface. At least one first ground conductor layer is positioned in a positive direction along a Z-axis from a signal conductor layer. The at least one first ground conductor layer is not positioned at a second positive main surface. A first substrate area in which a first substrate is disposed has an unoccupied-by-ground-conductor-layer area in which the at least one first ground conductor layer is not disposed when viewed in a negative direction along the Z-axis. The signal conductor layer overlaps the unoccupied-by-ground-conductor-layer area when viewed in the negative direction along the Z-axis. At a portion in the unoccupied-by-ground-conductor-layer area in the positive direction along the Z-axis from the signal conductor layer, no conductor other than a radiating conductor layer covers an entirety of the unoccupied-by-ground-conductor-layer area.

### CROSS-REFERENCE TO RELATED APPLICATIONS

The present application is a bypass continuation application of International Patent Application PCT/JP2023/032710, filed Sep. 7, 2023, which is based on and contains subject related to Japanese priority application JP 2022-163056, filed Oct. 11, 2022, the entire contents of each of which being incorporated by reference herein in its entirety.

### TECHNICAL FIELD

The present disclosure relates to an antenna module.

### BACKGROUND ART

As an example of an existing technology relating to an antenna module, a built-in antenna described in Patent Document 1 is known. This built-in antenna includes a dielectric substrate and a printed circuit board. On the upper main surface of the printed circuit board, an antenna pattern is disposed. The dielectric substrate is fixed to the upper main surface of the printed circuit board to cover the antenna pattern.

### CITATION LIST

### Patent Document

Patent Document 1: Japanese Unexamined Patent Application Publication No. 2003-179427

### SUMMARY

### Technical Problems

As an exemplary problem addressed by the present disclosure, the built-in antenna is described in Patent Document 1 as preferably including a minimized gap between the dielectric substrate and the printed circuit board.

The present disclosure aims to provide an antenna module that has a minimized gap between a first substrate and a second substrate.

### Solutions to Problems

An antenna module according to an aspect of the present disclosure is an antenna module that includes a first substrate and a second substrate,
wherein the first substrate includes
   a first substrate body containing a first insulating material, and
   a radiating conductor layer disposed at the first substrate body,
wherein the second substrate includes
   a second substrate body having a structure including a plurality of second insulator layers containing a second insulating material and laminated in a direction along a Z-axis,
   a signal conductor layer disposed at the second substrate body, and
   at least one first ground conductor layer disposed at the second substrate body,
wherein at least one of the first insulating material or the second insulating material is a thermoplastic resin,
wherein the first substrate body has a first positive main surface and a first negative main surface positioned in a negative direction along the Z-axis from the first positive main surface,
wherein the second substrate body has a second positive main surface and a second negative main surface positioned in the negative direction along the Z-axis from the second positive main surface,
wherein the second positive main surface is in contact with the first negative main surface,
wherein the at least one first ground conductor layer is positioned in a positive direction along the Z-axis from the signal conductor layer,
wherein the at least one first ground conductor layer is not positioned at the second positive main surface,
wherein the at least one first ground conductor layer partially overlaps the radiating conductor layer when viewed in the negative direction along the Z-axis,
wherein a first substrate area in which the first substrate is disposed has an unoccupied-by-ground-conductor-layer area in which the at least one first ground conductor layer is not disposed when viewed in the negative direction along the Z-axis,
wherein the signal conductor layer overlaps the unoccupied-by-ground-conductor-layer area when viewed in the negative direction along the Z-axis, and
wherein at a portion in the unoccupied-by-ground-conductor-layer area in the positive direction along the Z-axis from the signal conductor layer, no conductor other than the radiating conductor layer covers an entirety of the unoccupied-by-ground-conductor-layer area.

### Advantageous Effects of Disclosure

An antenna module according to the present disclosure has a minimized gap between a first substrate and a second substrate.

### BRIEF DESCRIPTION OF DRAWINGS

FIG. 1 is an exploded perspective view of an antenna module 10.

FIG. 2 is a top view of the antenna module 10.

FIG. 3 is a cross-sectional view of the antenna module 10.

FIG. 4 is a cross-sectional view of an antenna module 10a.

FIG. 5 is a cross-sectional view of an antenna module 10b.

FIG. 6 is a cross-sectional view of an antenna module 10c.

FIG. 7 is a cross-sectional view of an antenna module 10d.

FIG. 8 is a cross-sectional view of an antenna module 10e.

FIG. 9 is a cross-sectional view of an antenna module 10f.

FIG. 10 is a cross-sectional view of an antenna module 10g.

FIG. 11 is a cross-sectional view of an antenna module 10h.

FIG. 12 is an exploded perspective view of an antenna module 10i.

FIG. 13 is a cross-sectional view of an antenna module 10j.

FIG. 14 is a top view of a first substrate 12.

FIG. 15 is a top view of an antenna module 10l.

### DESCRIPTION OF EMBODIMENTS

### Embodiment

### [Structure of Antenna Module]

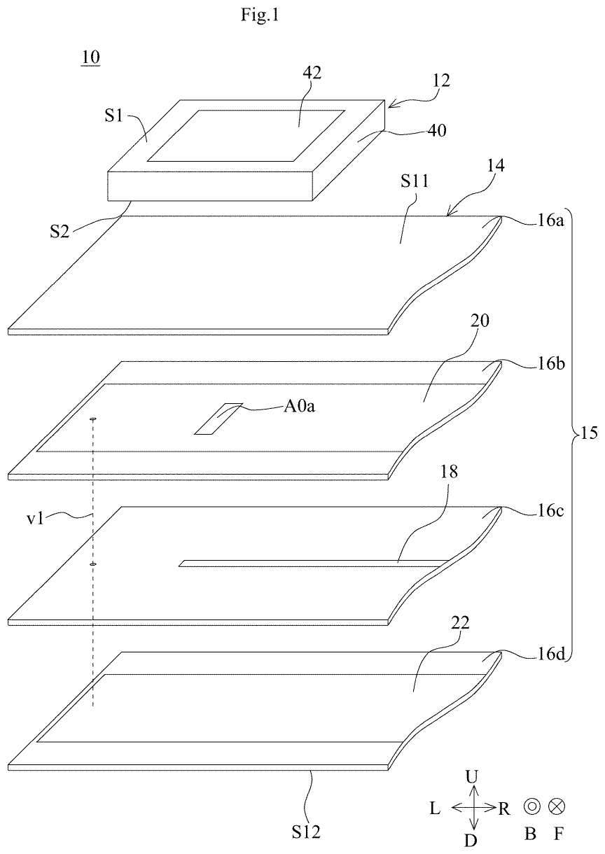

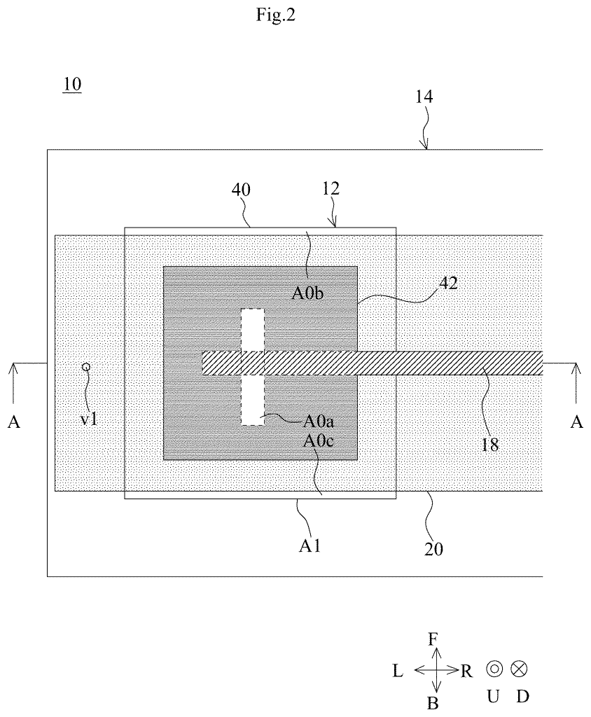

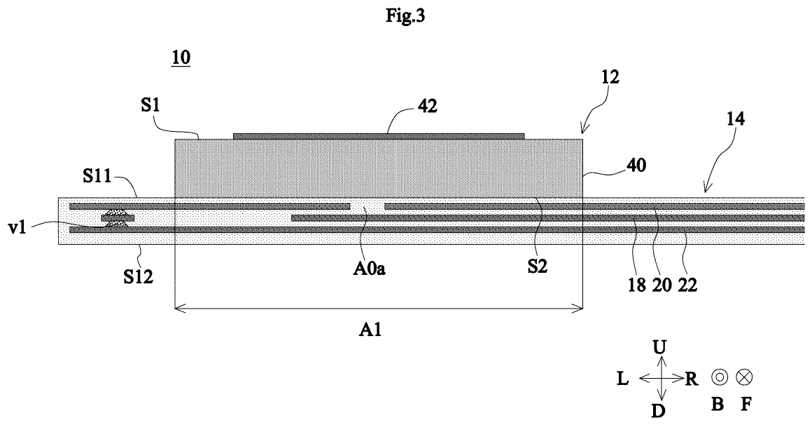

The structure of an antenna module 10 according to an embodiment of the present disclosure is described below with reference to the drawings. FIG. 1 is an exploded perspective view of an antenna module 10. FIG. 2 is a top view of the antenna module 10. FIG. 3 is a cross-sectional view of the antenna module 10, the cross-sectional view taken along line A-A in FIG. 2.

Herein, directions used in the drawings are defined in the manner below. The direction in which second insulator layers 16a to 16d are arranged in this order is defined as a downward direction. This downward direction aligns with a negative direction along a Z-axis (shown as “D” in FIG. 1 for example). When viewed downward, as shown in FIG. 2 for example, two sides of a first substrate 12 extend along a front-back axis. The front-back axis aligns with a Y-axis (shown as “F” and “B” in FIG. 2). The remaining two sides of the first substrate 12 extend along a lateral axis. The lateral axis aligns with an X-axis (“L” and “R” in FIG. 2). The vertical axis (Z-axis), the front-back axis (Y-axis), and the lateral axis (X-axis) are orthogonal to one another. The vertical axis, the front-back direction, and the lateral axis in the present embodiment may be misaligned with the vertical axis, the front-back axis, and the lateral axis during use of the antenna module 10.

First, with reference to FIG. 1 to FIG. 3, the structure of the antenna module 10 is described. The antenna module 10 is installed in an electronic device such as a radio communication terminal. As illustrated in FIG. 1, the antenna module 10 includes the first substrate 12 and a second substrate 14.

The first substrate 12 includes a first substrate body 40 and a radiating conductor layer 42. The first substrate body 40 has a plate shape. Thus, the first substrate body 40 has a first positive main surface S1 and a first negative main surface S2. The first negative main surface S2 is positioned below (in the negative direction along the Z-axis from) the first positive main surface S1. When viewed downward, the first substrate body 40 has a rectangular shape. When viewed downward, two sides of the first substrate body 40 extend along the front-back axis. The remaining two sides of the first substrate body 40 extend along the lateral axis. The first substrate body 40 contains a first insulating material. The first insulating material is not a thermoplastic resin. The first insulating material is, for example, a low temperature co-fired ceramic (LTCC) material.

The radiating conductor layer 42 is disposed at the first substrate body 40. In the present embodiment, the radiating conductor layer 42 is positioned at the first positive main surface S1 of the first substrate body 40. When viewed downward, the radiating conductor layer 42 has a rectangular shape. When viewed downward, two sides of the radiating conductor layer 42 extend along the front-back axis. The remaining two sides of the radiating conductor layer 42 extend along the lateral axis. The radiating conductor layer 42 is formed from a metal material. An example of metal is copper.

The second substrate 14 is positioned below the first substrate 12. The second substrate 14 includes a second substrate body 15, a signal conductor layer 18, a first ground conductor layer 20, a second ground conductor layer 22, and a first inter-layer connection conductor v1. The second substrate body 15 has a plate shape. Thus, the second substrate body 15 has a second positive main surface S11 and a second negative main surface S12. The second negative main surface S12 is positioned below (in the negative direction along the Z-axis from) the second positive main surface S11. The thickness of the second substrate 14 in the direction along the vertical axis (Z-axis) is smaller than the thickness of the first substrate 12 in the direction along the vertical axis (Z-axis). When viewed downward, the second substrate body 15 has an area greater than the area of the first substrate body 40. When viewed downward, an outer edge of the first substrate body 40 is located within an outer edge of the second substrate body 15.

The second substrate body 15 has a structure including the second insulator layers 16a to 16d containing a second insulating material and laminated in the direction along the vertical axis (Z-axis). The second insulator layers 16a to 16d are arranged downward in this order. Each of the second insulator layers 16a to 16d is fused with its adjacent layers. The second insulating material is a thermoplastic resin. The thermoplastic resin is, for example, a liquid crystal polymer. The dielectric constant of the second insulating material is lower than the dielectric constant of the first insulating material. In addition, the Young's modulus of the second insulating material is lower than the Young's modulus of the first insulating material.

The first substrate body 40 is fixed to the second substrate body 15. More specifically, the second positive main surface S11 is in contact with the first negative main surface S2. The first substrate body 40 is fixed to the second substrate body 15 with heat treatment and pressure treatment. In the heat treatment and the pressure treatment, the fused second insulator layer 16a fits to the recesses and protrusions on the surface of the first substrate body 40. Thus, the first substrate body 40 is in close contact with the second substrate body 15 and fixed to the second substrate body 15.

The signal conductor layer 18 is disposed at the second substrate body 15. In the present embodiment, the signal conductor layer 18 is positioned at the upper main surface of the second insulator layer 16c. The signal conductor layer 18 has a linear shape extending along the lateral axis (X-axis). A high-frequency signal is transmitted to the signal conductor layer 18 described above. In this context “high frequency” refers to radio frequency (RF) signals generally, and not signals in the HF communications band.

The first ground conductor layer 20 is disposed at the second substrate body 15. In the present embodiment, the first ground conductor layer 20 is positioned at the upper main surface of the second insulator layer 16b. Thus, the first ground conductor layer 20 is positioned above (in the positive direction along the Z-axis from) the signal conductor layer 18. The first ground conductor layer 20 is not positioned at the second positive main surface S11. Thus, the first ground conductor layer 20 is positioned inside the second substrate body 15.

The first ground conductor layer 20 covers a large part of the upper main surface of the second insulator layer 16b. Thus, the first ground conductor layer 20 overlaps the signal conductor layer 18 when viewed downward. However, the first ground conductor layer 20 is not electrically connected to the signal conductor layer 18. A part of the first ground conductor layer 20 overlaps the radiating conductor layer 42 when viewed downward (in the negative direction along the Z-axis). The first ground conductor layer 20 has a portion that does not overlap the radiating conductor layer 42 when viewed downward (in the negative direction along the Z-axis). The first ground conductor layer 20 with the above structure is electrically connected to ground potential.

The second ground conductor layer 22 is disposed at the second substrate body 15. In the present embodiment, the second ground conductor layer 22 is positioned at an upper main surface of the second insulator layer 16d. Thus, the second ground conductor layer 22 is positioned below (in the negative direction along the Z-axis from) the signal conductor layer 18.

The second ground conductor layer 22 covers a large part of the upper main surface of the second insulator layer 16d. Thus, the second ground conductor layer 22 overlaps the signal conductor layer 18 when viewed downward. The second ground conductor layer 22 overlaps the radiating conductor layer 42 when viewed downward (in the negative direction along the Z-axis). The second ground conductor layer 22 with the above structure is electrically connected to ground potential.

The signal conductor layer 18, the first ground conductor layer 20, and the second ground conductor layer 22 with the above structures have a stripline structure.

The signal conductor layer 18, the first ground conductor layer 20, and the second ground conductor layer 22 are formed by patterning metal foil attached to the upper main surfaces of the second insulator layers 16b to 16d. The metal foil is, for example, copper foil.

The first inter-layer connection conductor v1 electrically connects the first ground conductor layer 20 and the second ground conductor layer 22 to each other. The first inter-layer connection conductor v1 extends through the second insulator layers 16b and 16c along the vertical axis. The upper end of the first inter-layer connection conductor v1 is in contact with the first ground conductor layer 20. The lower end of the first inter-layer connection conductor v1 is in contact with the second ground conductor layer 22.

The first inter-layer connection conductor v1 is formed by filling, with electroconductive paste, a through-hole extending through the second insulator layers 16b and 16c along the vertical axis, and solidifying the electroconductive paste with heat treatment and pressure treatment.

As illustrated in FIG. 2, an area where the first substrate 12 is disposed when viewed downward (in the negative direction along the Z-axis) is defined as a first substrate area A1. The first substrate area A1 has unoccupied-by-ground-conductor-layer areas A0a, A0b, and A0c where the first ground conductor layer 20 is not disposed when viewed downward (in the negative direction along the Z-axis). The unoccupied-by-ground-conductor-layer area A0a has a rectangular shape when viewed downward. The two long sides of the unoccupied-by-ground-conductor-layer area A0a extend in the front-back direction. The two short sides of the unoccupied-by-ground-conductor-layer area A0a extend in the lateral direction. Thus, when viewed downward (in the negative direction along the Z-axis), the signal conductor layer 18 overlaps the unoccupied-by-ground-conductor-layer area A0a. More specifically, the unoccupied-by-ground-conductor-layer area A0a crosses the signal conductor layer 18 when viewed downward. In the present embodiment, the unoccupied-by-ground-conductor-layer area A0a is orthogonal to the signal conductor layer 18 when viewed downward. The unoccupied-by-ground-conductor-layer area A0a is surrounded by the first ground conductor layer 20 when viewed downward (in the negative direction along the Z-axis). The dimension of the unoccupied-by-ground-conductor-layer area A0a in the direction along the front-back axis (Y-axis) is smaller than or equal to a half of the wavelength of a radio-frequency signal transmitted through the signal conductor layer 18.

When viewed downward (in the negative direction along the Z-axis), in the unoccupied-by-ground-conductor-layer area A0a, the signal conductor layer 18 overlaps the radiating conductor layer 42. As illustrated in FIG. 3, in the unoccupied-by-ground-conductor-layer area A0a, no conductor other than the radiating conductor layer 42 covers the entirety of the unoccupied-by-ground-conductor-layer area A0a above (in the positive direction along the Z-axis from) the signal conductor layer 18. Thus, the signal conductor layer 18 and the radiating conductor layer 42 are electromagnetically coupled. In the present embodiment, the signal conductor layer 18 and the radiating conductor layer 42 are mainly magnetically coupled. Thus, a radio-frequency signal transmitted through the signal conductor layer 18 is transmitted to the radiating conductor layer 42 through the unoccupied-by-ground-conductor-layer area A0a with the electromagnetic field. In the radiating conductor layer 42, a stationary wave of the radio-frequency signal occurs. The radiating conductor layer 42 radiates an electromagnetic wave of the radio-frequency signal upward. With the same principle, the radiating conductor layer 42 receives the electromagnetic wave.

### Effects

The antenna module 10 has a minimized gap between the first substrate 12 and the second substrate 14. More specifically, the first ground conductor layer 20 is not positioned at the second positive main surface S11. In other words, the first ground conductor layer 20 is positioned in the second substrate body 15. Thus, the area over which the second positive main surface S11 and the first negative main surface S2 come into contact with each other increases. The first ground conductor layer 20 having a large area does not obstruct coupling between the first substrate 12 and the second substrate 14. Thus, the antenna module 10 has a minimized gap between the first substrate 12 and the second substrate 14.

At least one of the first insulating material or the second insulating material is a thermoplastic resin. In the present embodiment, the second insulating material is a thermoplastic resin. Thus, when the first substrate body 40 and the second substrate body 15 undergo heat treatment and pressure treatment, the fused second insulator layer 16a fits to the protrusions and recesses on the surface of the first substrate body 40. The first substrate body 40 thus comes into close contact with the second substrate body 15, and is fixed to the second substrate body 15. As described above, the second positive main surface S11 and the first negative main surface S2 come into close contact with each other over a large area. Thus, the antenna module 10 has a minimized gap between the first substrate 12 and the second substrate 14.

The first ground conductor layer 20 overlaps the radiating conductor layer 42, and the signal conductor layer 18. Thus, the first ground conductor layer 20 is located inside the first substrate area A1, and outside the first substrate area A1. In this case, the first ground conductor layer 20 may be disposed at the first substrate 12, and at the second substrate 14. Instead, the first ground conductor layer 20 is divided into sections to be disposed at multiple insulator layers.

The first ground conductor layer 20 is thus positioned inside the second substrate 14, instead of inside the first substrate 12. The first ground conductor layer 20 thus does not extend across the first substrate 12 and the second substrate 14. The first ground conductor layer 20 is thus positioned at the upper main surface of the second insulator layer 16b.

In the antenna module 10, the radiating conductor layer 42 has a reduced size. More specifically, the dielectric constant of the second insulating material is lower than the dielectric constant of the first insulating material. In other words, the dielectric constant of the first insulating material is higher than the dielectric constant of the second insulating material. Thus, the first substrate body 40 including the radiating conductor layer 42 has a wavelength shortening effect. Thus, the radiating conductor layer 42 has a reduced size.

The antenna module 10 has improved radiation efficiency. More specifically, the thickness of the second substrate 14 in the direction along the vertical axis is smaller than the thickness of the first substrate 12 in the direction along the vertical axis. In other words, the thickness of the first substrate 12 in the direction along the vertical axis is greater than the thickness of the second substrate 14 in the direction along the vertical axis. Thus, the distance between the radiating conductor layer 42 and the first ground conductor layer 20 is increased. Thus, the electromagnetic field around the radiating conductor layer 42 is more likely to leak from the first substrate 12. The antenna module 10 thus has improved radiation efficiency.

In the antenna module 10, the radiating conductor layer 42 is positioned at the first positive main surface S1. Thus, the distance between the radiating conductor layer 42 and the first ground conductor layer 20 is increased. The antenna module 10 thus has improved radiation efficiency.

In the antenna module 10, the distance between the radiating conductor layer 42 and the first ground conductor layer 20 is less likely to vary. More specifically, the Young's modulus of the second insulating material is lower than the Young's modulus of the first insulating material. In other words, the Young's modulus of the first insulating material is higher than the Young's modulus of the second insulating material. Thus, the first substrate body 40 is less easily deformed. The distance between the radiating conductor layer 42 and the first ground conductor layer 20 is thus less likely to vary.

In the antenna module 10, the second substrate 14 is greater than the first substrate 12. Thus, the second substrate 14 can be bent, and the antenna module 10 can be disposed in a gap having a bent shape.

In the antenna module 10, solder is not used to couple the first substrate 12 and the second substrate 14. Thus, the thickness of the antenna module 10 in the direction along the vertical axis is determined by the thickness of the first substrate 12 in the vertical direction and the thickness of the second substrate 14 in the vertical direction. Thus, the distance between the radiating conductor layer 42 and the signal conductor layer 18 is less likely to vary, and the variation in radiation characteristics of the antenna module 10 is reduced.

In the antenna module 10, the first insulating material and the second insulating material are different. Thus, an inexpensive material may be used for either the first insulating material or the second insulating material. Thus, the antenna module 10 can be manufactured with reduced costs.

### First Modification Example

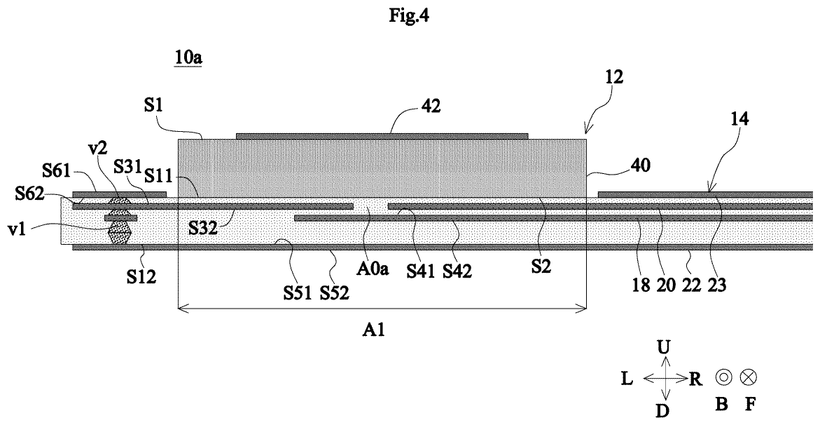

With reference to the drawings, an antenna module 10a according to a first modification example is described below. FIG. 4 is a cross-sectional view of the antenna module 10a.

The antenna module 10a differs from the antenna module 10 in that it further includes a third ground conductor layer 23 and a second inter-layer connection conductor v2. The third ground conductor layer 23 is positioned at the upper main surface of the second insulator layer 16a. However, when viewed downward, the third ground conductor layer 23 is not disposed in the first substrate area A1 where the first substrate body 40 is disposed.

The second inter-layer connection conductor v2 electrically connects the first ground conductor layer 20 and the third ground conductor layer 23 to each other. The second inter-layer connection conductor v2 extends through the second insulator layer 16a along the vertical axis. The upper end of the second insulator layer 16a is in contact with the third ground conductor layer 23. The lower end of the second insulator layer 16a is in contact with the first ground conductor layer 20.

The first ground conductor layer 20 has a third positive main surface S31 and a third negative main surface S32. The third negative main surface S32 is positioned below (in the negative direction along the Z-axis from) the third positive main surface S31. The surface roughness of the third positive main surface S31 is smaller than the surface roughness of the third negative main surface S32.

The signal conductor layer 18 has a fourth positive main surface S41 and a fourth negative main surface S42. The fourth negative main surface S42 is positioned below the fourth positive main surface S41. The surface roughness of the fourth positive main surface S41 is smaller than the surface roughness of the fourth negative main surface S42.

The second ground conductor layer 22 is positioned at the lower main surface of the second insulator layer 16d. The second ground conductor layer 22 has a fifth positive main surface S51 and a fifth negative main surface S52. The fifth negative main surface S52 is positioned below the fifth positive main surface S51. The surface roughness of the fifth negative main surface S52 is smaller than the surface roughness of the fifth positive main surface S51.

The third ground conductor layer 23 has a sixth positive main surface S61 and a sixth negative main surface S62. The sixth negative main surface S62 is positioned below the sixth positive main surface S61. The surface roughness of the sixth positive main surface S61 is smaller than the surface roughness of the sixth negative main surface S62. Other components of the antenna module 10a are the same as those of the antenna module 10, and thus are not described. The antenna module 10a has the same effects as the antenna module 10.

In the antenna module 10a, the surface roughness of the third positive main surface S31 is smaller than the surface roughness of the third negative main surface S32. The radiating conductor layer 42 thus faces the third positive main surface S31 having smaller surface roughness. Thus, the radiating conductor layer 42 has reduced power loss. When resonance occurs in the radiating conductor layer 42, a reduced loss is caused by resonance current flowing near the third positive main surface S31.

### Second Modification Example

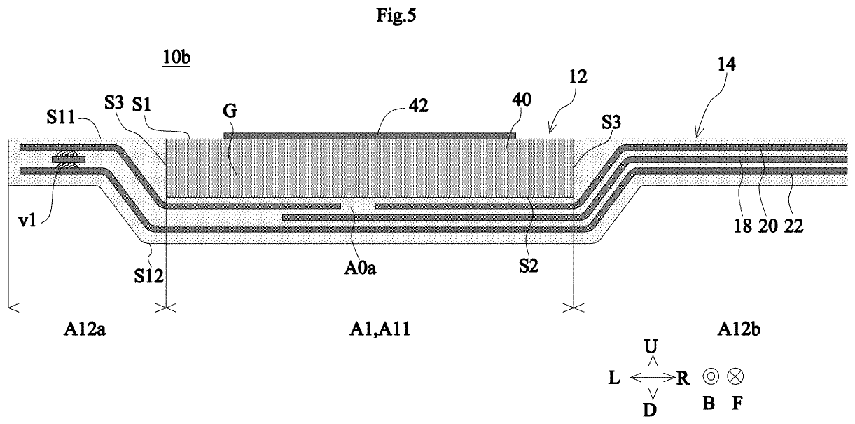

With reference to the drawings, an antenna module 10b according to a second modification example is described below. FIG. 5 is a cross-sectional view of the antenna module 10b.

The antenna module 10b differs from the antenna module 10 in that a hollow G (or hollow portion G) is formed in the second substrate body 15, and the first substrate 12 is positioned in the hollow G. More specifically, to fix the first substrate 12 to the second substrate 14, the first substrate 12 and the second substrate 14 undergo heat treatment and pressure treatment. At this time, the second substrate 14 is deformed by being pushed downward by the first substrate 12. Thus, the hollow G is formed in the second substrate body 15, and the first substrate 12 is positioned in the hollow G.

The first substrate body 40 has first side surfaces S3 that connect the first positive main surface S1 and the first negative main surface S2. When the first substrates 12 are positioned in the hollow G, the first side surfaces S3 are in contact with the second substrate body 15.

When viewed downward (in the negative direction along the Z-axis), the second substrate body 15 includes a first section A11 that overlaps the first substrate 12, and second sections A12a and A12b that do not overlap the first substrate 12 when viewed downward (in the negative direction along the Z-axis). The first positive main surface S1 and the second positive main surface S11 in the second sections A12a and A12b are flush in a single plane. More specifically, the position of the first positive main surface S1 along the vertical axis is the same as the position, along the vertical axis, of the second positive main surface S11 in the second sections A12a and A12b.

Parts of the first ground conductor layer 20 in the second sections A12a and A12b are positioned above (in the positive direction along the Z-axis from) the first negative main surface S2. Other components of the antenna module 10b are the same as those in the antenna module 10, and thus are not described. The antenna module 10b has the same effects as the antenna module 10.

The antenna module 10b has improved gain. More specifically, the first ground conductor layer 20 is located in front of, behind, to the left of, and to the right of the space between the radiating conductor layer 42 and the first ground conductor layer 20. More specifically, when viewed downward, the space between the radiating conductor layer 42 and the first ground conductor layer 20 is surrounded by the first ground conductor layer 20. This structure reduces leakage of the electromagnetic field from the space between the radiating conductor layer 42 and the first ground conductor layer 20. Thus, the antenna module 10b has improved gain.

In the antenna module 10b, parts of the first ground conductor layer 20 in the second sections A12a and A12b are positioned above (in the positive direction along the Z-axis from) the first negative main surface S2. Thus, when viewed downward, the space between the radiating conductor layer 42 and the first ground conductor layer 20 is surrounded by the first ground conductor layer 20. Thus, when the antenna module 10b includes multiple radiating conductor layers 42, electromagnetic field coupling between the multiple radiating conductor layers 42 is reduced.

In the antenna module 10b, a portion of the first ground conductor layer 20 positioned below the radiating conductor layer 42 and portions of the first ground conductor layer 20 positioned in front of, behind, to the left of, and to the right of the radiating conductor layer 42 are continuous with one another. Thus, the antenna module 10b does not have to include an inter-layer connection conductor with an inductance component. Thus, the EM radiation band of the antenna module 10b is widened. When viewed downward, the first ground conductor layer 20 surrounds the first substrate 12. This structure reduces leakage of the electric field from the first side surfaces S3 of the first substrate 12, and reduces occurrence of noise.

In the antenna module 10b, the first positive main surface S1 and the second positive main surface S11 in the second sections A12a and A12b are flush in a single plane. Thus, the upper main surface of the antenna module 10b approximates to a flat surface. This structure enables arrangement of other components near the upper main surface of the antenna module 10b.

### Third Modification Example

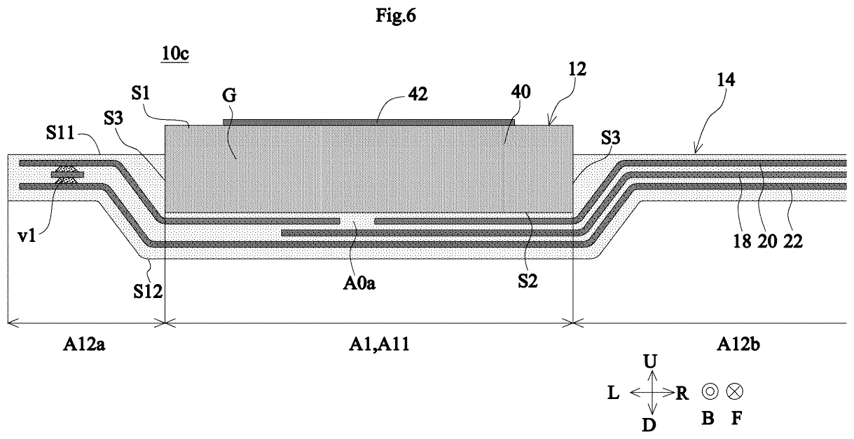

With reference to the drawings, an antenna module 10c according to a third modification example is described below. FIG. 6 is a cross-sectional view of the antenna module 10c.

The antenna module 10c differs from the antenna module 10b in that the first substrate body 40 has a greater thickness in the direction along the vertical axis. Thus, the first substrate body 40 protrudes upward from the second positive main surface S11 of the second substrate body 15. Other components of the antenna module 10c are same as those of the antenna module 10b, and thus are not described. The antenna module 10c has the same effects as the antenna module 10b.

In the antenna module 10c, the first substrate body 40 has a greater thickness in the direction along the vertical axis. Thus, the distance between the radiating conductor layer 42 and the first ground conductor layer 20 is increased. The antenna module 10c thus has improved radiation efficiency.

### Fourth Modification Example

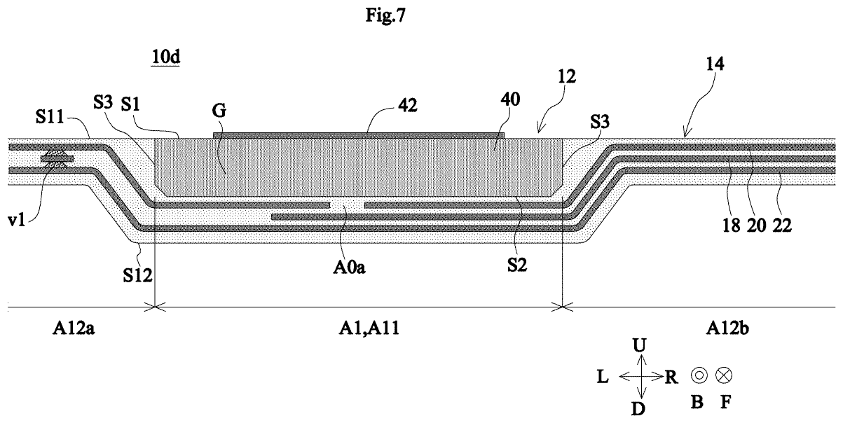

With reference to the drawings, an antenna module 10d according to a fourth modification example is described below. FIG. 7 is a cross-sectional view of the antenna module 10d.

The antenna module 10d differs from the antenna module 10b in that edges defined by the first side surfaces S3 and the first negative main surface S2 are chamfered. In the present embodiment, edges defined by the first side surfaces S3 and the first negative main surface S2 are chamfered at 45 degrees. Other components of the antenna module 10d are the same as those of the antenna module 10b, and thus are not described. The antenna module 10d has the same effects as the antenna module 10b.

In the antenna module 10d, edges defined by the first side surfaces S3 and the first negative main surface S2 are chamfered. Thus, the second substrate body 15 has a reduced amount of deformation. In addition, the first substrate body 40 and the second substrate body 15 come into closer contact with each other.

### Fifth Modification Example

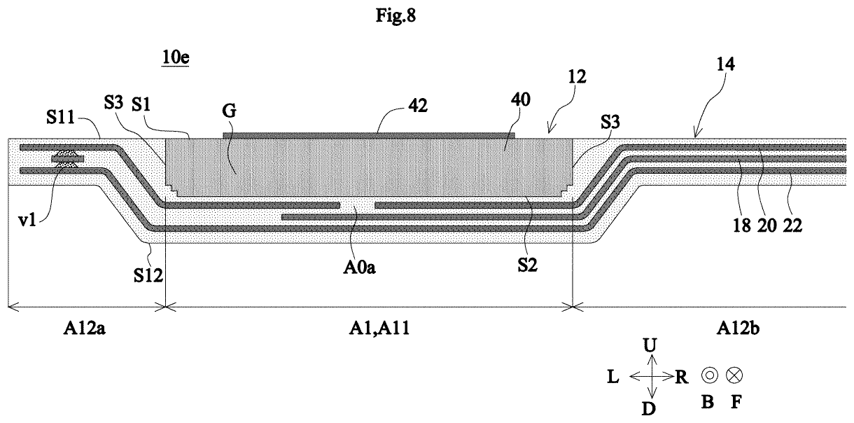

With reference to the drawings, an antenna module 10e according to a fifth modification example is described below. FIG. 8 is a cross-sectional view of the antenna module 10e.

The antenna module 10e differs from the antenna module 10b in that edges defined by the first side surfaces S3 and the first negative main surface S2 each have one or more steps. Other components of the antenna module 10e are the same as those of the antenna module 10b, and thus are not described. The antenna module 10e has the same effects as the antenna module 10b.

In the antenna module 10e, the edges defined by the first side surfaces S3 and the first negative main surface S2 each have one or more steps. Thus, the second substrate body 15 has a reduced amount of deformation. The first substrate body 40 and the second substrate body 15 are thus in closer contact with each other.

### Sixth Modification Example

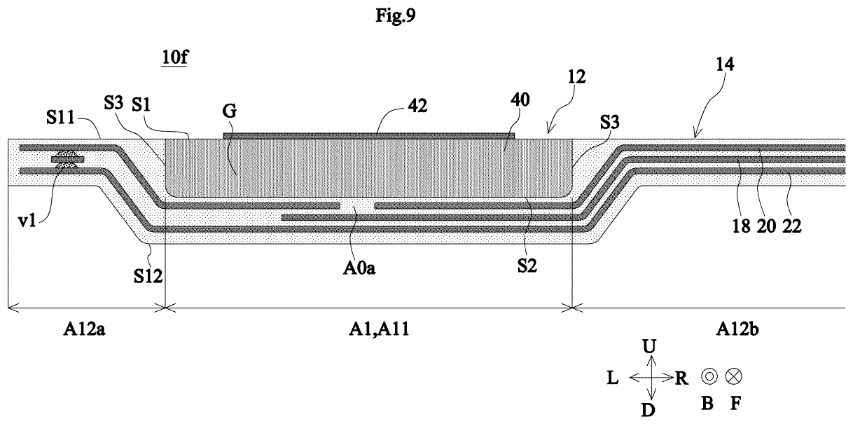

With reference to the drawings, an antenna module 10f according to a sixth modification example is described below. FIG. 9 is a cross-sectional view of the antenna module 10f.

The antenna module 10f differs from the antenna module 10b in that, edges defined by the first side surfaces S3 and the first negative main surface S2 are chamfered. In the present embodiment, the edges defined by the first side surfaces S3 and the first negative main surface S2 are rounded. Other components of the antenna module 10f are the same as those of the antenna module 10b, and thus are not described. The antenna module 10f has the same effects as the antenna module 10b.

In the antenna module 10f, edges defined by the first side surfaces S3 and the first negative main surface S2 are chamfered. Thus, the second substrate body 15 has a reduced amount of deformation. In addition, the first substrate body 40 and the second substrate body 15 are in closer contact with each other.

### Seventh Modification Example

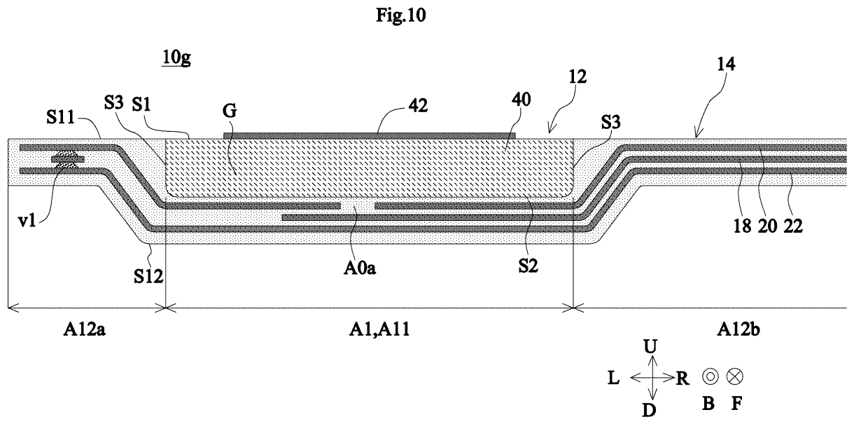

With reference to the drawings, an antenna module 10g according to a seventh modification example is described below. FIG. 10 is a cross-sectional view of the antenna module 10g.

The antenna module 10g differs from the antenna module 10f in that the first insulating material is a thermoplastic resin. When the first insulating material is a thermoplastic resin, the edges defined by the first side surfaces S3 and the first negative main surface S2 are deformed while the first substrate 12 and the second substrate 14 undergo pressure treatment and heat treatment. The edges defined by the first side surfaces S3 and the first negative main surface S2 are thus rounded. Other components of the antenna module 10g are the same as those of the antenna module 10f, and thus are not described. The antenna module 10g has the same effects as the antenna module 10f.

In the antenna module 10g, the first insulating material is a thermoplastic resin. Thus, when the first substrate 12 and the second substrate 14 undergo pressure treatment and heat treatment, the edges defined by the first side surfaces S3 and the first negative main surface S2 are deformed. Thus, the second substrate body 15 has a reduced amount of deformation. In addition, the first substrate body 40 and the second substrate body 15 are in closer contact with each other.

### Eighth Modification Example

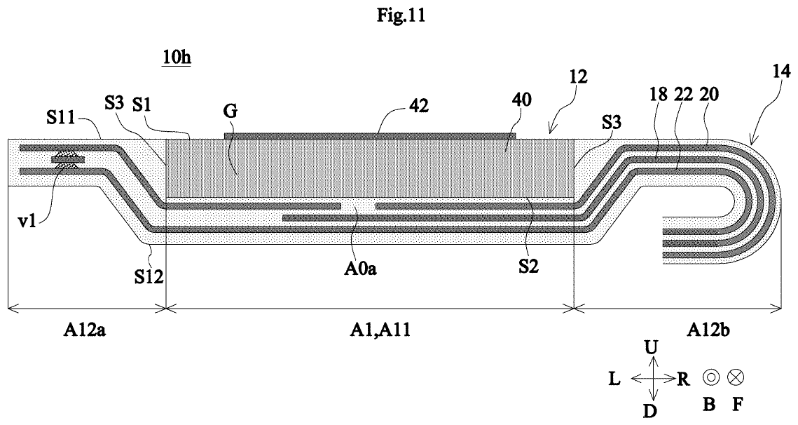

With reference to the drawings, an antenna module 10h according to an eighth modification example is described below. FIG. 11 is a cross-sectional view of the antenna module 10h.

The antenna module 10h differs from the antenna module 10b in that the second section A12b of the second substrate 14 is bent when viewed forward (in a direction orthogonal to the Z-axis). Other components of the antenna module 10h are the same as those of the antenna module 10b, and thus are not described. The antenna module 10h has the same effects as the antenna module 10b.

### Ninth Modification Example

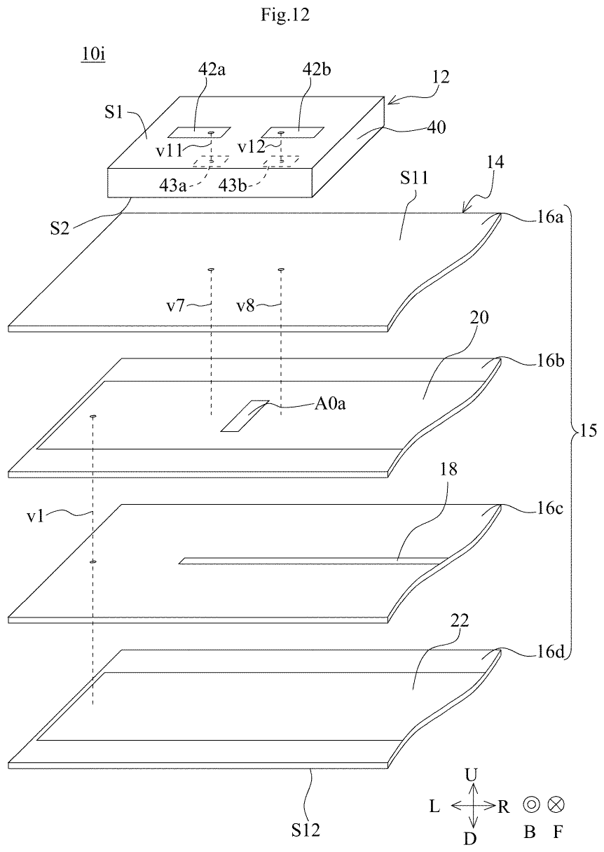

With reference to the drawings, an antenna module 10i according to a ninth modification example is described below. FIG. 12 is an exploded perspective view of the antenna module 10i.

The antenna module 10i differs from the antenna module 10 in the following points.
Instead of the radiating conductor layer 42, the antenna module 10i includes radiating conductor layers 42a and 42b.
The first substrate 12 further includes outer electrodes 43a and 43b and inter-layer connection conductors v11 and v12.
The second substrate 14 further includes inter-layer connection conductors v7 and v8.

The radiating conductor layers 42a and 42b are positioned at the first positive main surface S1 of the first substrate body 40. The radiating conductor layers 42a and 42b have a rectangular shape when viewed downward. The radiating conductor layer 42a is positioned to the left of the unoccupied-by-ground-conductor-layer area A0a when viewed downward. The radiating conductor layer 42b is positioned to the right of the unoccupied-by-ground-conductor-layer area A0a when viewed downward.

The outer electrodes 43a and 43b are positioned at the first negative main surface S2 of the first substrate body 40. The outer electrodes 43a and 43b have a rectangular shape when viewed downward. The outer electrode 43a overlaps the radiating conductor layer 42a when viewed downward. The outer electrode 43b overlaps the radiating conductor layer 42b when viewed downward. The entireties of the outer electrodes 43a and 43b overlap the first ground conductor layer 20 when viewed downward.

The inter-layer connection conductor v11 electrically connects the radiating conductor layer 42a and the outer electrode 43a to each other. The inter-layer connection conductor v11 extends through the first substrate body 40 along the vertical axis. The upper end of the inter-layer connection conductor v11 is in contact with the radiating conductor layer 42a. The lower end of the inter-layer connection conductor v11 is in contact with the outer electrode 43a.

The inter-layer connection conductor v12 electrically connects the radiating conductor layer 42b and the outer electrode 43b to each other. The inter-layer connection conductor v12 extends through the first substrate body 40 along the vertical axis. The upper end of the inter-layer connection conductor v12 is in contact with the radiating conductor layer 42b. The lower end of the inter-layer connection conductor v12 is in contact with the outer electrode 43b.

The inter-layer connection conductor v7 electrically connects the first ground conductor layer 20 and the outer electrode 43a to each other. The inter-layer connection conductor v7 extends through the second insulator layer 16a along the vertical axis. The upper end of the inter-layer connection conductor v7 is exposed through the upper main surface of the second insulator layer 16a. The upper end of the inter-layer connection conductor v7 is in contact with the outer electrode 43a. The lower end of the inter-layer connection conductor v7 is in contact with the first ground conductor layer 20.

The inter-layer connection conductor v8 electrically connects the first ground conductor layer 20 and the outer electrode 43b to each other. The inter-layer connection conductor v8 extends through the second insulator layer 16a along the vertical axis. The upper end of the inter-layer connection conductor v8 is exposed through the upper main surface of the second insulator layer 16a. The upper end of the inter-layer connection conductor v8 is in contact with the outer electrode 43b. The lower end of the inter-layer connection conductor v8 is in contact with the first ground conductor layer 20.

Other components of the antenna module 10i are the same as those of the antenna module 10b, and thus are not described. The antenna module 10i has the same effects as the antenna module 10b.

The antenna module 10i includes the inter-layer connection conductors v11 and v12. Thus, the design freedom of an antenna including the radiating conductor layer 42 improves. The design freedom of the directivity of the antenna module 10i thus increases.

### Tenth Modification Example

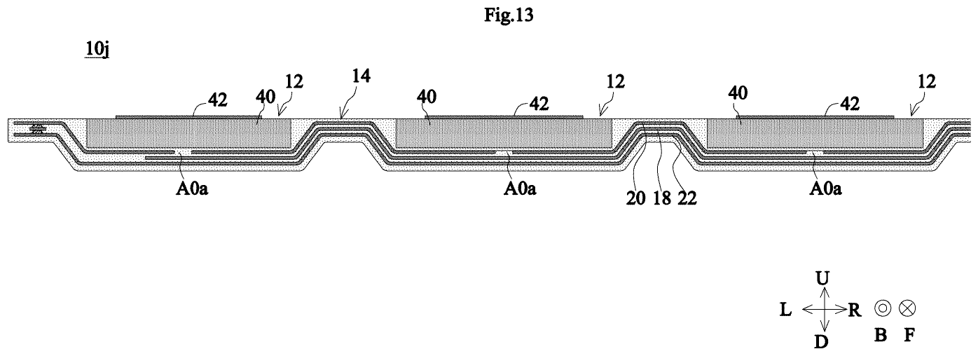

With reference to the drawings, an antenna module 10j according to a tenth modification example is described below. FIG. 13 is a cross-sectional view of the antenna module 10j.

The antenna module 10j differs from the antenna module 10b in that it includes three first substrates 12. As in this structure, the antenna module 10j may include multiple radiating conductor layers 42.

### Eleventh Modification Example

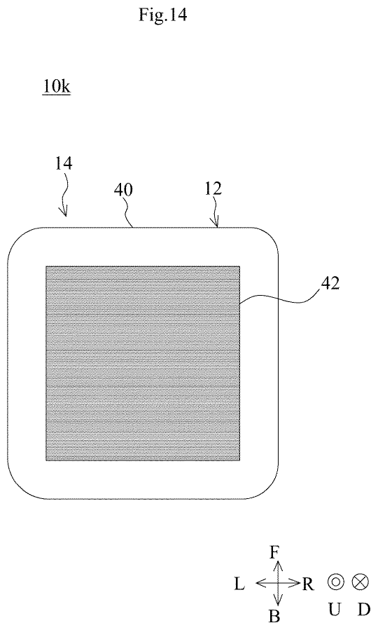

With reference to the drawings, an antenna module 10k according to an eleventh modification example is described below. FIG. 14 is a top view of the first substrate 12.

The antenna module 10k differs from the antenna module 10b in the shape of the first substrate body 40. When viewed downward, four corners of the first substrate body 40 are chamfered. More specifically, when viewed downward, four corners of the first substrate body 40 are rounded. Other components of the antenna module 10k are the same as those of the antenna module 10b, and thus are not described. The antenna module 10k has the same effects as the antenna module 10b.

In the antenna module 10k, when viewed downward, the four corners of the first substrate body 40 are chamfered. Thus, the second substrate body 15 has a reduced amount of deformation. In addition, the first substrate body 40 and the second substrate body 15 are in closer contact with each other.

### Twelfth Modification Example

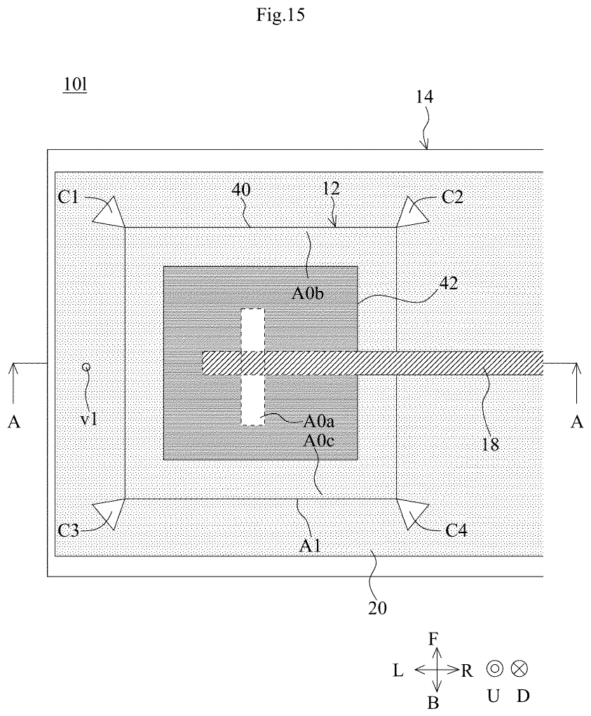

With reference to the drawings, an antenna module 10l according to a twelfth modification example is described below. FIG. 15 is a top view of the antenna module 10l. FIG. 15 illustrates the first substrate 12 before being fixed to the second substrate 14.

The antenna module 10l differs from the antenna module 10b in that it has notches C1 to C4 in the first ground conductor layer 20. The notch C1 is located near the front left corner of the first substrate body 40. The notch C2 is located near the front right corner of the first substrate body 40. The notch C3 is located near the back left corner of the first substrate body 40. The notch C4 is located near the back right corner of the first substrate body 40. Other components of the antenna module 10l are the same as those of the antenna module 10b, and thus are not described. The antenna module 10l has the same effects as the antenna module 10b.

The antenna module 10l has the notches C1 to C4 in the first ground conductor layer 20. Thus, while the first substrate 12 is being fixed to the second substrate 14, the first ground conductor layer 20 is not creased near the four corners of the first substrate body 40.

### Other Embodiments

The present invention is not limited to the antenna modules 10 and 10a to 101, and an antenna module according to the present invention is changeable within its scope. Components in the antenna modules 10 and 10a to 101 may be combined as appropriate.

At least one of the first insulating material or the second insulating material is a thermoplastic resin. Thus, instead of the second insulating material, the first insulating material may be a thermoplastic resin.

The first insulating material and the second insulating material may be the same material. In this case, warpage of the first substrate 12 and the second substrate 14 is reduced.

The number of the first ground conductor layers is not limited to one. The number of the first ground conductor layers may be one or more. When the number of the first ground conductor layers is two, the unoccupied-by-ground-conductor-layer area A0a is disposed between the two first ground conductor layers. In this case, the periphery of the unoccupied-by-ground-conductor-layer area A0a is not surrounded by the first ground conductor layer. For example, when viewed downward, the first ground conductor layer is not located in front of or behind the unoccupied-by-ground-conductor-layer area A0a. Portions of the two first ground conductor layers overlap the radiating conductor layer 42 when viewed downward.

The dielectric constant of the second insulating material may be higher than or equal to the dielectric constant of the first insulating material. In this case, the capacitance between the radiating conductor layer 42 and the first ground conductor layer 20 is reduced. Thus, the antenna module has improved radiation efficiency.

The surface roughness of the third positive main surface S31 may be higher than or equal to the surface roughness of the third negative main surface S32.

The thickness of the second substrate 14 in the direction along the vertical axis may be greater than or equal to the thickness of the first substrate 12 in the direction along the vertical axis.

The Young's modulus of the second insulating material may be higher than or equal to the Young's modulus of the first insulating material.

The radiating conductor layer 42 may be positioned inside the first substrate body 40. In this case, the radiating conductor layer 42 is protected by the first substrate body 40.

The radiating conductor layer 42 may be positioned at the first negative main surface S2 of the first substrate body 40. In this case, the electromagnetic field coupling between the radiating conductor layer 42 and the signal conductor layer 18 is enhanced.

The thickness of the first substrate body 40 in the direction along the vertical axis is greater than the thickness of the second substrate body 15 in the direction along the vertical axis. Thus, when the first substrate body 40 has a structure in which multiple first insulator layers are laminated, the first insulator layers may have a greater thickness than the thickness of the second insulator layers 16a to 16d to reduce the number of sheets.

The second ground conductor layer 22 is not an essential component.

Each of the antenna modules 10 and 10a to 101 may include multiple first inter-layer connection conductors v1.

Non-limiting aspects of the present disclosure include structures like that below.

(1)

An antenna module, comprising:
a first substrate; and
a second substrate,
wherein the first substrate includes
   a first substrate body containing a first insulating material, and
   a radiating conductor layer disposed at the first substrate body,
wherein the second substrate includes
   a second substrate body having a structure including a plurality of second insulator layers containing a second insulating material and laminated in a direction along a Z-axis,
   a signal conductor layer disposed at the second substrate body, and
   at least one first ground conductor layer disposed at the second substrate body,
wherein at least one of the first insulating material or the second insulating material is a thermoplastic resin,
wherein the first substrate body has a first positive main surface and a first negative main surface positioned in a negative direction along the Z-axis from the first positive main surface,
wherein the second substrate body has a second positive main surface and a second negative main surface positioned in the negative direction along the Z-axis from the second positive main surface,
wherein the second positive main surface is in contact with the first negative main surface,
wherein the at least one first ground conductor layer is positioned in a positive direction along the Z-axis from the signal conductor layer,
wherein the at least one first ground conductor layer is not positioned at the second positive main surface,
wherein the at least one first ground conductor layer partially overlaps the radiating conductor layer when viewed in the negative direction along the Z-axis,
wherein a first substrate area in which the first substrate is disposed has an unoccupied-by-ground-conductor-layer area in which the at least one first ground conductor layer is not disposed when viewed in the negative direction along the Z-axis,
wherein the signal conductor layer overlaps the unoccupied-by-ground-conductor-layer area when viewed in the negative direction along the Z-axis, and
wherein at a portion in the unoccupied-by-ground-conductor-layer area in the positive direction along the Z-axis from the signal conductor layer, no conductor other than the radiating conductor layer covers an entirety of the unoccupied-by-ground-conductor-layer area.
   (2)

The antenna module according to (1),
wherein a dielectric constant of the second insulating material is lower than a dielectric constant of the first insulating material.
   (3)

The antenna module according to (1) or (2),
wherein the first ground conductor layer has a third positive main surface and a third negative main surface positioned in the negative direction along the Z-axis from the third positive main surface, and
wherein surface roughness of the third positive main surface is smaller than surface roughness of the third negative main surface.
   (4)

The antenna module according to any one of (1) to (3),
wherein a thickness of the second substrate in a direction along the Z-axis is smaller than a thickness of the first substrate in the direction along the Z-axis.
   (5)

The antenna module according to any one of (1) to (4),
wherein Young's modulus of the second insulating material is lower than Young's modulus of the first insulating material.
   (6)

The antenna module according to any one of (1) to (5),
wherein the first substrate body has a first side surface that connects the first positive main surface and the first negative main surface to each other, and
wherein the first side surface is in contact with the second substrate body.
   (7)

The antenna module according to (6),
wherein the second substrate body has a first section that overlaps the first substrate when viewed in the negative direction along the Z-axis, and a second section that does not overlap the first substrate when viewed in the negative direction along the Z-axis, and
wherein a portion of the first ground conductor layer in the second section is positioned in the positive direction along the Z-axis from the first negative main surface.
   (8)

The antenna module according to (6) or (7),
wherein the second substrate body has a first section that overlaps the first substrate when viewed in the negative direction along the Z-axis, and a second section that does not overlap the first substrate when viewed in the negative direction along the Z-axis, and
wherein the first positive main surface and the second positive main surface in the second section are flush in a single plane.
   (9)

The antenna module according to any one of (6) to (8),
wherein an edge defined by the first side surface and the first negative main surface is chamfered.
   (10)

The antenna module according to any one of (6) to (8),
wherein an edge defined by the first side surface and the first negative main surface has one or more steps.
   (11)

The antenna module according to any one of (1) to (10),
wherein the first insulating material is a thermoplastic resin.
   (12)

The antenna module according to any one of (1) to (10),
wherein the second insulating material is a thermoplastic resin.
   (13)

The antenna module according to any one of (1) to (12),
wherein the second substrate has a first section that overlaps the first substrate when viewed in the negative direction along the Z-axis, and a second section that does not overlap the first substrate when viewed in the negative direction along the Z-axis, and
wherein the second section of the second substrate is bent when viewed in a direction orthogonal to the Z-axis.
   (14)

The antenna module according to any one of (1) to (13),
wherein the signal conductor layer extends along an X-axis,
wherein a Y-axis is orthogonal to the X-axis and the Z-axis, and
wherein a dimension of the unoccupied-by-ground-conductor-layer area in a direction along the Y-axis is smaller than or equal to a half of a wavelength of a radio-frequency signal that is transmitted through the signal conductor layer.
   (15)

The antenna module according to any one of (1) to (14),
wherein the signal conductor layer extends along an X-axis,
wherein a Y-axis is orthogonal to the X-axis and the Z-axis, and
wherein the unoccupied-by-ground-conductor-layer area is surrounded by the first ground conductor layer when viewed in the negative direction along the Z-axis.
   (16)

The antenna module according to any one of (1) to (15),
wherein the second substrate further includes
   a second ground conductor layer disposed at the second substrate body,
wherein the second ground conductor layer is positioned in the negative direction along the Z-axis from the signal conductor layer, and
wherein the second ground conductor layer overlaps the radiating conductor layer when viewed in the negative direction along the Z-axis.

### REFERENCE SIGNS LIST

10, 10a to 101 antenna module
12 first substrate
14 second substrate
15 second substrate body
16a to 16d second insulator layer
18 signal conductor layer
20 first ground conductor layer
22 second ground conductor layer
23 third ground conductor layer
40 first substrate body
42, 42a, 42b radiating conductor layer
43a, 43b outer electrode
A0a unoccupied-by-ground-conductor-layer area
A1 first substrate area
A11 first section
A12a, A12b second section
G hollow
S1 first positive main surface
S11 second positive main surface
S12 second negative main surface
S2 first negative main surface
S3 first side surface
S31 third positive main surface
S32 third negative main surface
S41 fourth positive main surface
S42 fourth negative main surface
S51 fifth positive main surface
S52 fifth negative main surface
S61 sixth positive main surface
S62 sixth negative main surface

1. An antenna module, comprising:
a first substrate that includes
a first substrate body containing a first insulating material, and
a radiating conductor layer disposed at the first substrate body; and
a second substrate that includes
a second substrate body having a plurality of second insulator layers containing a second insulating material and laminated in a direction along a Z-axis,
a signal conductor layer disposed at the second substrate body, and
at least one first ground conductor layer disposed at the second substrate body, wherein
at least one of the first insulating material or the second insulating material is a thermoplastic resin,
the first substrate body has a first positive main surface and a first negative main surface positioned in a negative direction along the Z-axis from the first positive main surface,
the second substrate body has a second positive main surface and a second negative main surface positioned in the negative direction along the Z-axis from the second positive main surface,
the second positive main surface is in contact with the first negative main surface,
the at least one first ground conductor layer is positioned in a positive direction along the Z-axis from the signal conductor layer,
the at least one first ground conductor layer is not positioned at the second positive main surface,
the at least one first ground conductor layer partially overlaps the radiating conductor layer when viewed in the negative direction along the Z-axis,
a first substrate area in which the first substrate is disposed has an unoccupied-by-ground-conductor-layer area in which the at least one first ground conductor layer is not disposed when viewed in the negative direction along the Z-axis,
the signal conductor layer overlaps the unoccupied-by-ground-conductor-layer area when viewed in the negative direction along the Z-axis, and
at a portion in the unoccupied-by-ground-conductor-layer area in the positive direction along the Z-axis from the signal conductor layer, no conductor other than the radiating conductor layer covers an entirety of the unoccupied-by-ground-conductor-layer area.

2. The antenna module according to claim 1,
wherein a dielectric constant of the second insulating material is lower than a dielectric constant of the first insulating material.

3. The antenna module according to claim 1,
wherein the first ground conductor layer has a third positive main surface and a third negative main surface positioned in the negative direction along the Z-axis from the third positive main surface, and
wherein a degree of surface roughness of the third positive main surface is smaller than a degree of surface roughness of the third negative main surface.

4. The antenna module according to claim 1,
wherein a thickness of the second substrate in a direction along the Z-axis is smaller than a thickness of the first substrate in the direction along the Z-axis.

5. The antenna module according to claim 1,
wherein a Young's modulus of the second insulating material is lower than a Young's modulus of the first insulating material.

6. The antenna module according to claim 1,
wherein the first substrate body has a first side surface that connects the first positive main surface and the first negative main surface to each other, and
wherein the first side surface is in contact with the second substrate body.

7. The antenna module according to claim 6,
wherein the second substrate body has a first section that overlaps the first substrate when viewed in the negative direction along the Z-axis, and a second section that does not overlap the first substrate when viewed in the negative direction along the Z-axis, and
wherein a portion of the first ground conductor layer in the second section is positioned in the positive direction along the Z-axis from the first negative main surface.

8. The antenna module according to claim 6,
wherein the second substrate body has a first section that overlaps the first substrate when viewed in the negative direction along the Z-axis, and a second section that does not overlap the first substrate when viewed in the negative direction along the Z-axis, and
wherein the first positive main surface and the second positive main surface in the second section are flush in a single plane.

9. The antenna module according to claim 7,
wherein the second substrate body has a first section that overlaps the first substrate when viewed in the negative direction along the Z-axis, and a second section that does not overlap the first substrate when viewed in the negative direction along the Z-axis, and
wherein the first positive main surface and the second positive main surface in the second section are flush in a single plane.

10. The antenna module according to claim 6,
wherein an edge defined by the first side surface and the first negative main surface is chamfered.

11. The antenna module according to claim 7,
wherein an edge defined by the first side surface and the first negative main surface is chamfered.

12. The antenna module according to claim 6,
wherein an edge defined by the first side surface and the first negative main surface has one or more steps.

13. The antenna module according to claim 7,
wherein an edge defined by the first side surface and the first negative main surface has one or more steps.

14. The antenna module according to claim 1,
wherein the first insulating material is a thermoplastic resin.

15. The antenna module according to claim 1,
wherein the second insulating material is a thermoplastic resin.

16. The antenna module according to claim 1,
wherein the second substrate has a first section that overlaps the first substrate when viewed in the negative direction along the Z-axis, and a second section that does not overlap the first substrate when viewed in the negative direction along the Z-axis, and
wherein the second section of the second substrate is bent when viewed in a direction orthogonal to the Z-axis.

17. The antenna module according to claim 1,
wherein the signal conductor layer extends along an X-axis,
wherein a Y-axis is orthogonal to the X-axis and the Z-axis, and
wherein a dimension of the unoccupied-by-ground-conductor-layer area in a direction along the Y-axis is smaller than or equal to a half of a wavelength of a radio-frequency signal that is transmitted through the signal conductor layer.

18. The antenna module according to claim 1,
wherein the signal conductor layer extends along an X-axis,
wherein a Y-axis is orthogonal to the X-axis and the Z-axis, and
wherein the unoccupied-by-ground-conductor-layer area is surrounded by the first ground conductor layer when viewed in the negative direction along the Z-axis.

19. The antenna module according to claim 17,
wherein the signal conductor layer extends along an X-axis,
wherein a Y-axis is orthogonal to the X-axis and the Z-axis, and
wherein the unoccupied-by-ground-conductor-layer area is surrounded by the first ground conductor layer when viewed in the negative direction along the Z-axis.

20. The antenna module according to claim 1,
wherein the second substrate further includes
a second ground conductor layer disposed at the second substrate body,
the second ground conductor layer is positioned in the negative direction along the Z-axis from the signal conductor layer, and
the second ground conductor layer overlaps the radiating conductor layer when viewed in the negative direction along the Z-axis.
